(19) United States
(12) Patent Application Publication
(10) Pub. No.: US 2015/0135868 A1
(43) Pub. Date: May 21, 2015

(54) ELECTROMECHANICAL DRIVING ACTUATOR WITH DAMPING DEVICE

(71) Applicants: Vyacheslav Viktorovich Nikolaev, Saint-Petersburg (RU); Vadim Igorevich Dunaev, Saint-Petersburg (RU); Mikhail Evgenievich Fedosovsky, Saint-Petersburg (RU)

(72) Inventors: Vyacheslav Viktorovich Nikolaev, Saint-Petersburg (RU); Vadim Igorevich Dunaev, Saint-Petersburg (RU); Mikhail Evgenievich Fedosovsky, Saint-Petersburg (RU)

(21) Appl. No.: 14/538,656

(22) Filed: Nov. 11, 2014

Related U.S. Application Data
(63) Continuation-in-part of application No. PCT/RU2013/000370, filed on Apr. 29, 2013.

(30) Foreign Application Priority Data
May 11, 2012 (EA) 201200702

(51) Int. Cl. F16H 25/20; F16H 25/22

(52) U.S. Cl. CPC F16H 25/2015; F16H 25/2252; F16H 2025/204; F16H 2025/2075
USPC 74/89.34

(57) ABSTRACT

An electromechanical driving actuator with a damping device comprises an electric motor (26) comprising a stator (9) and a hollow rotor (3), the stator (9) enclosing the rotor (3) and the rotor having a base end and an operational end. The electromechanical actuator further comprises a retractable shaft (4) having a cavity and mounted coaxially with the rotor (3) in such a manner that an end portion of the retractable shaft (4) is arranged in the cavity of the rotor, the shaft's end portion being formed as a tubular member (8) having a bottom end and an operational end. The electromechanical driving actuator further comprises an internally-threaded bushing (1) mounted within the tubular member (8) and rigidly connected thereto, externally-threaded rollers (7) mounted within the threaded bushing (1) circumferentially so that the rollers' axes are parallel to the rotor's axis and the rollers' thread engages the internal thread of the threaded bushing (1), an externally-threaded screw member (2) having a support end and an actuating end, the screw member being located within the threaded bushing (1) coaxially with the rotor (3) in such a manner that the screw member's thread engages the thread of the rollers (7) and that the support end of the screw member (2) is rigidly connected to the rotor (3). The actuating end of the screw member (2) is arranged in the cavity of the retractable shaft (4). The retractable shaft can be moved between the furthest extended position and the furthest retracted position thereof defined, respectively, by disk-spring packs (5, 6). Non-rotatable disk-spring pack (5) is rigidly fixed at the base end of the rotor (3) on the interior thereof so as to be rotated in conjunction with the rotor and to engage the operational end of the tubular member (8). Rotatable disk-spring pack (6) is rigidly fixed at the bottom end of the tubular member (8) from the outside thereof and engages the operational end of the rotor from the interior thereof. The electromechanical driving actuator provides a rapid and precise movement of the operating member and simultaneously damps oscillations arising in the extreme positions of the retractable shaft.

This application is a continuation-in-part of International application PCT/RU2013/000370 filed on Apr. 29, 2013 which claims priority benefits to Eurasian patent application EA 201200702 filed on May 11, 2012. Each of these applications is incorporated herein by reference for all purposes.

### FIELD OF THE INVENTION

The present invention relates generally to electromechanical linear actuators and, in particular, to an electromechanical driving actuator. The invention can be used to move a riding cut-off valve in a control system to control a turbine unite, thus providing better safety for a nuclear power plant.

### BACKGROUND OF THE INVENTION

One safety means for a nuclear power plant is a driving actuator which is utilized to activate a riding cut-off valve of a turbine unit. When activated, the riding cut-off valve provides movement along several tens of millimeters in several tens of milliseconds, thus rapidly changing flow of the operational fluid. In this connection, it is desirable that such driving actuator is highly reliable in operation and rapidly and precisely determines positions of the actuator's operating member which engages the riding cut-off valve. During this engagement, it is desirable to rapidly stop the shaft and to damp impacts arising when the actuator's operating member approaches its furthest extended position or its furthest retracted position wherein end faces of the actuator's operating member are coming into engagement with adjacently disposed parts.

Known in the art is use of electromechanical driving actuators comprising damping devices. These known electromechanical driving actuators are designed on basis a roller-screw gear utilized to convert rotational motion into linear motion, thus controlling apparatuses and tools coupled thereto. Particularly, RU2009138441 discloses an electromechanical driving actuator which comprises a damping device and which can be utilized to provide movement in a riding cut-off valve in a control system of a turbine unit.

### SUMMARY OF THE INVENTION

This known electromechanical driving actuator is designed on basis of a roller-screw gear and comprises an electric motor including a stator and a hollow rotor. The stator encloses the rotor which has a base end and an operational end. An operational member of this actuator is a retractable shaft having a cavity and mounted coaxially with the rotor so as to be prevented from rotation around the shaft's axis and in such a manner that an end portion of the retractable shaft is arranged in the cavity of the rotor, wherein said end portion is a tubular member having a bottom end and an operational end. In this known electromechanical driving actuator, the roller-screw gear is composed by a threaded bushing, rollers, and a screw member. The threaded bushing is an internally-threaded bushing which is mounted within the tubular member and is rigidly connected thereto. The rollers are provided with external thread and are arranged within the threaded bushing circumferentially so that the rollers' axes are parallel to the rotor's axis. The screw member is an externally-threaded screw member and has a support end and an actuating end. The screw member is arranged within the threaded bushing coaxially with the rotor in such a manner that the screw member's thread engages the thread of the rollers and the support end of the screw member is rigidly connected to the rotor. The actuating end of the screw member is arranged in the cavity of the retractable shaft.

The retractable shaft can be moved between its furthest extended position and its furthest retracted position defined, respectively, by limiting springing members, such as two disk-spring packs attached respectively at opposite ends of the tubular member. Further, the two disk-spring packs function as a damping device damping impacts of the retractable shaft by damping kinetic energy of moving parts in the electromechanical driving actuator when the retractable shaft achieves the furthest extended position or the furthest retracted position thereof.

One of the two disk-spring packs is arranged at the bottom end of the tubular member so that the springs are arranged around base of the retractable shaft. The other of the two disk-spring packs is arranged parallel to the first disk-spring pack and on an annular ledge covering as a ring the opposite, i.e. the operational, end of the tubular member. Springs of the second disk-spring pack are arranged around the screw member.

Outside retraction of the retractable shaft is limited by a face end of the enclosure which houses the electric motor and against which the first disk-spring pack becomes pressed when the retractable shaft achieves its furthest extended position. When the retractable shaft approaches its furthest extended position, the first disk-spring pack moves linearly to engage a face end of the stationary enclosure from the interior thereof and becomes pressed against it. This results in a forced stop of the retractable shaft in its extended position and in simultaneous damping of impacts which may arise.

On the other hand, a reversal motion of the retractable shaft being retracted inside the enclosure is limited from the interior of the enclosure by a face end of the rotating rotor; wherein in the furthest retracted position of the retractable shaft, the second disk-spring pack becomes pressed against the face end of the rotating rotor. In operation, when the retractable shaft approaches the furthest retracted position, the second disk-spring pack moves linearly to engage the face end of the rotating rotor from the interior thereof and becomes pressed against it. This results in a forced stop of the retractable shaft.

In practice, however, damping capacity of the known electromechanical driving actuator is not sufficient to adequately damp impacts arising when the retractable shaft achieves its extreme positions after being moved at high speed.

Thus, an object of the present invention is to address this shortcoming and to improve damping capacity of damping members so as to eliminate impacts arising when the retractable shaft achieves its extreme positions after being moved at high speed.

The object is achieved by providing a linear electromechanical driving actuator comprising damping means which differ from damping means used in the prior art solution.

In the prior art, both damping members are rigidly fixed at outside face ends of the tubular member which can be moved linearly within the cavity of the rotor. In contrast, an actuator in accordance with the present invention comprises two damping members formed as limiting springing members, wherein one of the limiting springing members is rigidly fixed at the base end of the rotor on the interior thereof so as to be rotated in conjunction with the rotor and to engage the operational end of the tubular member; and the other of the limiting springing members is rigidly fixed at the bottom end of the tubular member from the outside thereof and engages the operational end of the rotor from the interior thereof.

This configuration of the actuator, particularly of its rotatable limiting springing members, provides better damping capacity of its damping members as resulted from better dissipability of kinetic energy in the moving parts, which further leads to lower impact loads arising in extreme positions of the retractable shaft. On the one hand, the better damping capacity is provided by rotatability of the one of the limiting springing members upon contact with the operational end of the tubular member and, on the other hand, the better damping capacity is provided by engageability of the other of the limiting springing members with the rotating operational end of the rotor from the interior thereof.

In a preferred embodiment, the damping device of the electromechanical driving actuator comprises two disk-spring packs. One pack of the two disk-spring packs is rotatable and another pack of the two disk-spring packs is non-rotatable. The non-rotatable disk-spring pack moves reciprocally in conjunction with the retractable shaft. In contrast, the rotatable disk-spring pack moves rotatably in conjunction with the rotor.

When the retractable shaft approaches its furthest retracted position, in which the shaft is fully retracted, the rotating disk-spring pack begins to gradually engage the retractable shaft which does not rotate; to be more precise, the rotating disk-spring pack begins to gradually engage the tubular member's operational end formed integrally with the shaft. In doing this, damping is achieved due to gradual increase of friction torque between springs of the rotatable disk-spring pack engaging the operational end of the tubular member.

When the retractable shaft approaches its furthest extended position, in which the shaft is fully extended, the non-rotatable disk-spring pack moves linearly to engage the rotating operational end of the rotor from the interior thereof and becomes pressed against it. A gradually increasing engagement between the non-rotatable disk-spring pack and the operational end of the rotating rotor leads to gradual increase of friction torque, thus providing the desirable damping.

In a preferred embodiment, the operational end of the rotor and the operational end of the tubular member each are covered by thrust annular ledges extending transversely to the rotor's axis and/or to the tubular member's axis. These ledges protect spaces inside, respectively, the tubular member and the rotor from dirt accumulation.

In one embodiment, the thrust ledges are formed integrally with the rotor and the tubular member, respectively, thus improving constructional integrity and durability of the electromechanical driving actuator assembly.

In yet another embodiment, the thrust ledges are detachable respectively from the rotor and from the tubular member. This embodiment enables rapid replaceability of worn moving parts and simplified cleaning and lubrication of space, respectively, inside the tubular member and inside the rotor.

The rotor in the electric motor as used in the electromechanical driving actuator can rotate either clockwise to cause movement of the retractable shaft in one direction, e.g. for closing the riding cut-off valve, or can rotate counterclockwise to cause movement of the retractable shaft in another direction, e.g. for opening the riding cut-off valve.

To ensure reliable operation the electromechanical driving actuator, at least two sets of pole magnets are fixed on the rotor and assigned thereto so as one set of pole magnets is arranged coaxially with the other set of pole magnets one behind the other. Said sets of pole magnets are respectively enclosed by sets of pole magnets assigned to the stator, wherein one set of pole magnets assigned to the stator is arranged coaxially with the other set of pole magnets assigned to the stator so as to be positioned one behind the other.

Thus configured, the electromechanical driving actuator in accordance with the present invention provides duplication backup of electrical power means in the actuator. For further duplication backup, electrical connectors, the control coil in the braking device, and a feedback sensor are formed in duplicate.

The feedback sensor allows to reliably determine a current position of the retractable shaft c [symbol] and then to provide a suitable indicating signal. Upon receiving a signal indicating change in working position of the riding cut-off valve, one pair of stator-rotor is actuated in the motor. If this pair of stator-rotor fails to be actuated, the other pair of stator-rotor can be actuated.

Furthermore, the electromechanical driving actuator in accordance with the present invention provides absence of play between its parts and high accuracy in moving the retractable shaft engaging the riding cut-off valve. The electromechanical driving actuator in accordance with the present invention exhibits high performance and allows, with minimal power, for high reliability and speed in controlling positions of the riding cut-off valve used in a nuclear power plant turbine.

### BRIEF DESCRIPTION OF THE DRAWINGS

FIG. 1 is a schematic cross-sectional view of the electromechanical driving actuator in accordance with the present invention.

FIG. 2 is a schematic cross-sectional view of the electromechanical driving actuator in accordance with the present invention as taken along line A-A in FIG. 1.

FIG. 3 schematically shows the structure of the spring-loaded lever arm of the electromechanical driving actuator in accordance with the present invention, as seen in view B in FIG. 2.

### DETAILED DESCRIPTION OF THE PREFERRED EMBODIMENTS

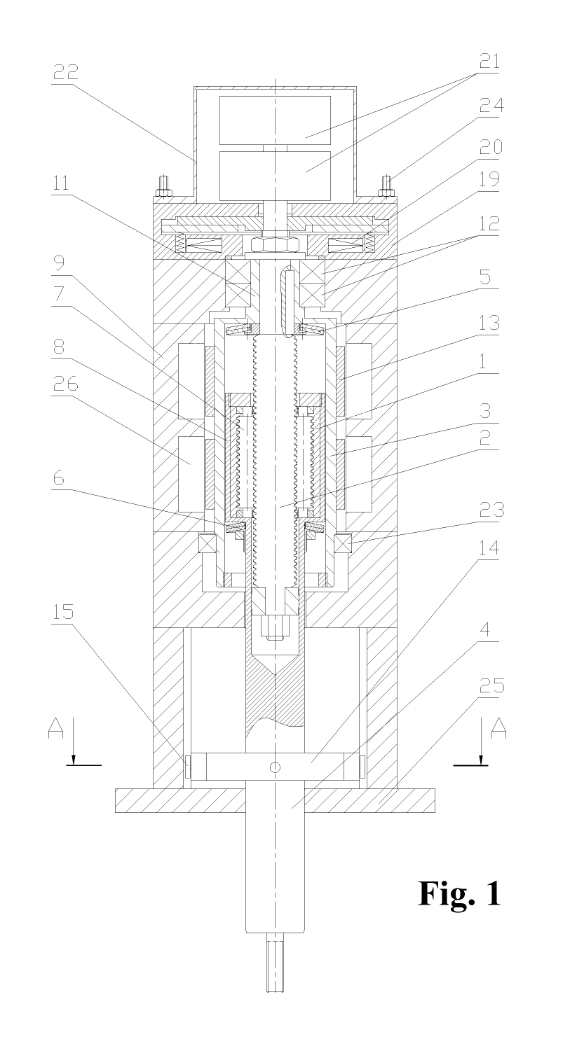

As can be seen in FIG. 1, an electromechanical driving actuator in accordance with the present invention comprises an electric motor 26 comprising a stator 9 and a hollow rotor 3. The stator 9 encloses the rotor 3 which has a base end and an operational end. With reference to FIG. 1, the base end of the rotor 3 is positioned at the top of FIG. 1 and the operational end of the rotor 3 is positioned at the bottom of FIG. 1. A working or operational member of the driving actuator is a retractable shaft 4 having a cavity and mounted coaxially with the rotor 3 so as to be prevented from rotation around the shaft's axis. An end portion of the retractable shaft 4 is arranged in the cavity of the rotor 3. This end portion is formed as a tubular member 8 having a bottom end and an operational end. With reference to FIG. 1, the bottom end of the tubular member 8 is positioned at the bottom of FIG. 1 and the operational end of the rotor 3 is positioned at the top of FIG. 1.

The electromechanical driving actuator comprises a threaded bushing 1, rollers 7, and a screw member 2 which collectively define a roller-screw gear. The threaded bushing 1 is an internally-threaded bushing which is mounted within the tubular member 8 and rigidly connected thereto. The rollers 7 are provided with external thread and are circumferentially arranged within the threaded bushing 1 so that the rollers' axes are parallel to the rotor's axis. In a preferred embodiment, nine rollers 7 are arranged in a roller holder. The screw member 2 is an externally-threaded screw member and has a support end and an actuating end. With reference to FIG. 1, the support end of the screw member 2 is positioned at the top of FIG. 1 and the actuating end of the screw member 2 is positioned at the bottom of FIG. 1. The screw member 2 is arranged within the threaded bushing 1 coaxially with the rotor 3 in such a manner that the screw member's thread engages the thread of the rollers 7 and the support end of the screw member 2 is rigidly connected to the rotor 3. The actuating end of the screw member 2 is arranged in the cavity of the retractable shaft 4 and is rotationally supported therein by means of ball bearings. Preferably, the tubular member 8 is arranged at the end of the retractable shaft 4 and is formed integrally therewith. Thus, the threaded bushing 1 is rigidly connected to the inner end of the retractable shaft 4. An outer end of the retractable shaft 4, functioning as an operating member of the electromechanical driving actuator, is coupled to a shut-off member, such as a riding cut-off valve.

Rigid connection between the screw member 2 and the rotor 3 is realized by attaching the support end of the screw member 2 rigidly to a hub 11 of the rotor 3. The hub 11 is arranged close to the base end of the rotor 3 and is rotationally supported by dual radial-thrust bearings of a bearing assembly 12 which provide backlash-free rotation of the rotor 3. The operational end of the rotor 3 is rotationally supported by radial-thrust bearings of another bearing assembly 23. Two sets of pole magnets 13 are fixed on the rotor 3 and assigned thereto so as one set of pole magnets 13 is arranged coaxially with the other set of pole magnets 13 one behind the other. Said sets of pole magnets 13 are respectively enclosed by sets of pole magnets assigned to the stator 9, wherein one set of pole magnets assigned to the stator 9 is arranged coaxially with the other set of pole magnets assigned to the stator 9 so as to be positioned one behind the other.

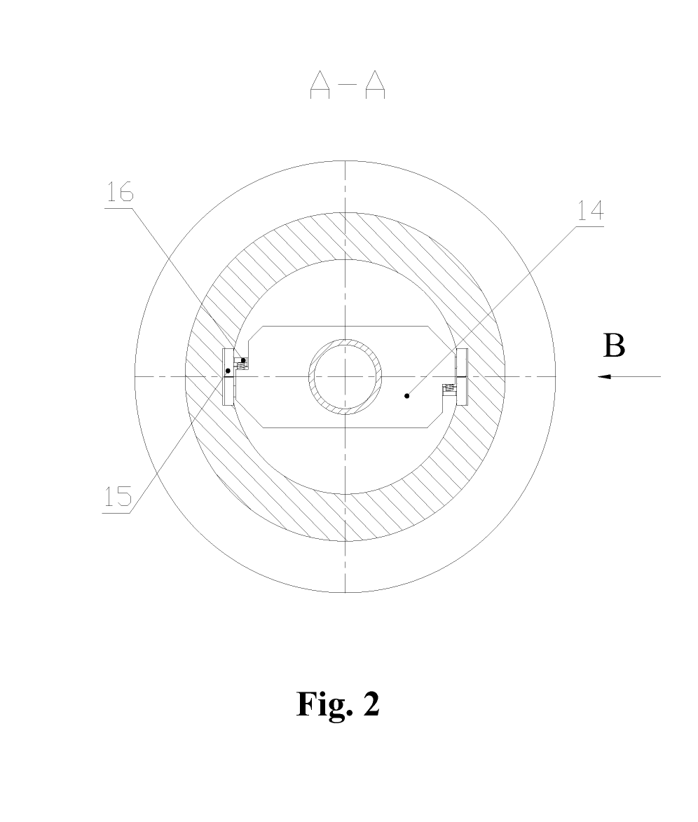

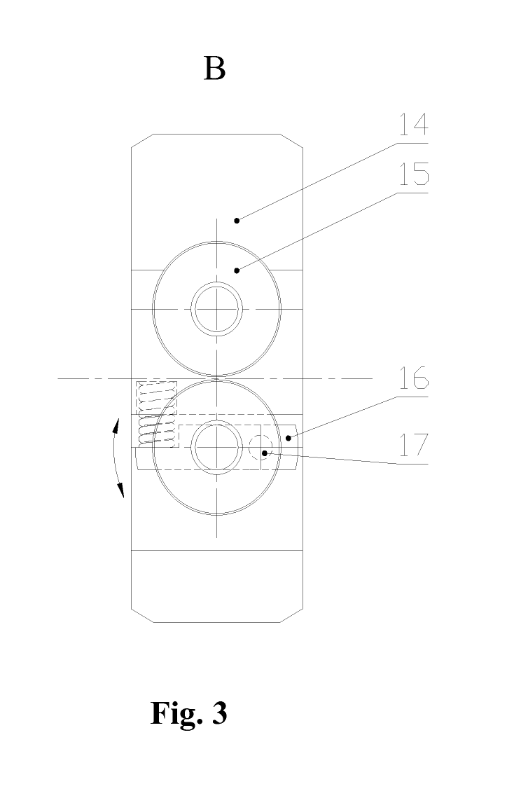

The retractable shaft 4 is prevented from rotation around its longitudinal axis by means of an anti-rotational device comprising a rocker arm 14 which is mounted on the retractable shaft 4 extending transversely thereto and which is rigidly fixed thereon. At each end of the rocker arm 14, a pair of wheels 15 (FIG. 2) is mounted, wherein the wheels' axes extend substantially transversely to a longitudinal axis of the retractable shaft 4. Stationary are an axis of one wheel 15 in one said pair and an axis of one wheel 15 in the other said pair which is mounted at the opposite end of the rocker arm 14 as arranged diametrically opposed relative to the longitudinal axis of the shaft 4. The other two opposed wheels 15 are spring-biased because they are mounted at spring-biased levers 16 (FIG. 3) which angularly move around their axes 17, wherein rotational axis of the spring-biased wheel is spaced from rotational axis of the spring-biased lever at a distance of several millimeters. Angular play in the rocker arm 14 is eliminated due to minimization of clearance between the wheels 15 and inner surface of guiding longitudinal grooves in a cylinder 18 (FIG. 1).

The electromechanical driving actuator also comprises a braking device 19 including two control coils 20 and two feedback sensors 21 fixed at cylindrical portion of the screw member 2 and covered by a cap 22. The enclosure of an assembled electromechanical driving actuator according to the present invention is defined by the cap 22, a braking device 19, a bearing assembly 12, an electric motor 26, a bearing assembly 23, the cylinder 18, and a mounting flange 25 which collectively are held assembled by means of draw studs 24.

The retractable shaft 4 can be moved between the furthest extended position and the furthest retracted position thereof defined, respectively, by disk springs 5 [symbol] 6 fixed at opposite ends of the tubular member 8. One of the disk springs (5) is mounted at the bottom end of the tubular member 8 and is arranged around base of the retractable shaft 4. The other of the disk springs (6) is mounted generally parallel to the disk spring 5 and on an annular ledge covering as a ring the opposite, i.e. the operational, end of the tubular member 2. The disk spring 6 is arranged around the screw member 2.

When the actuator is operated, rotation of the hollow rotor 3 in the electric motor 26 causes rotation of the screw member 2. External threads of the screw member 2 engage threads of rollers 7 which circumferentially enclose the screw member 2 so as to cause rotation of the rollers 7 around their axes. The threads of the rollers 7 also engage the internal thread of the threaded bushing 1. Rotation of the rollers 7 causes linear movement of the threaded bushing 1 which is rigidly connected to the retractable shaft 4 via the tubular member 8 and which causes translational motion of the shut-off member. Depending on the rotational direction of the rotor 3, the riding cut-off valve (not shown) is either closed or opened.

### LIST OF REFERENTIAL SIGNS

1 threaded bushing
2 screw member
3 rotor
4 retractable shaft
5 limiting springing member
6 limiting springing member
7 rollers
8 tubular member of the threaded bushing
9 stator
11 hub of the rotor
12 bearing assembly to support the base end of the rotor
13 pole magnets
14 rocker arm of the anti-rotational device
15 [symbol] of the anti-rotational device
16 [symbol] of the anti-rotational device
17 axis in the lever of the anti-rotational device
18 cylinder of enclosure of the electromechanical driving actuator
19 braking device
20 control coils of the braking device
21 feedback sensor
22 cap covering the feedback sensors
23 bearing assembly to support an operational end of the rotor
24 draw stud
25 mounting flange
26 electric motor

1. An electromechanical driving actuator comprising
an electric motor comprising a stator and a hollow rotor, the stator enclosing the rotor and the rotor having a base end and an operational end,
a retractable shaft having a cavity and mounted coaxially with the rotor so as to be prevented from rotation around the shaft's axis, wherein an end portion of the retractable shaft is arranged in the cavity of the rotor and said end portion is a tubular member having a bottom end and an operational end,
an internally-threaded bushing mounted within the tubular member and rigidly connected thereto,
externally-threaded rollers mounted within the threaded bushing circumferentially, wherein the rollers' axes are parallel to the rotor's axis and the rollers' thread engages the internal thread of the threaded bushing,
an externally-threaded screw member having a support end and an actuating end, the screw member being located within the threaded bushing coaxially with the rotor, wherein the screw member's thread engages the thread of the rollers, the support end of the screw member is rigidly connected to the rotor, and the actuating end of the screw member is arranged in the cavity of the retractable shaft, wherein the motion of the retractable shaft is limited by limiting springing members in the furthest extended position and in the furthest retracted position, respectively,
wherein
one of the limiting springing members is rigidly fixed at the base end of the rotor on the interior thereof so as to be rotated in conjunction with the rotor and to engage the operational end of the tubular member and
the other of the limiting springing members is rigidly fixed at the bottom end of the tubular member on the outside thereof so as to engage the operational end of the rotor from the interior thereof.

2. The electromechanical driving actuator of claim 1, wherein the limiting springing members are disk springs.

3. The electromechanical driving actuator of claim 1, wherein the operational end of the rotor comprises a ledge extending transversely to the rotor's axis.

4. The electromechanical driving actuator of claim 3, wherein said ledge of the operational end of the rotor is integral with the rotor.

5. The electromechanical driving actuator of claim 3, wherein said ledge of the operational end of the rotor is detachable from the rotor.

6. The electromechanical driving actuator of claim 1, wherein the operational end of the tubular member comprises a ledge extending transversely to the rotor's axis.

7. The electromechanical driving actuator of claim 6, wherein said ledge of the operational end of the tubular member is integral with the tubular member.

8. The electromechanical driving actuator of claim 6, wherein said ledge of the operational end of the tubular member is detachable from the tubular member.
